(19) United States
(12) Patent Application Publication
(10) Pub. No.: US 2008/0251002 A1
(43) Pub. Date: Oct. 16, 2008

(54) Tension Indicator

(75) Inventor: David Burleigh, West Sussex (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: BRITAX EXCELSIOR LIMITED, Hampshire (GB)

(21) Appl. No.: 11/568,798

(22) PCT Filed: Apr. 15, 2005
(86) PCT No.: PCT/GB2005/001469

§ 371 Date: Apr. 11, 2008

(30) Foreign Application Priority Data
May 7, 2004 (GB) 0410185.3

(51) Int. Cl. G01L 5/00; B60R 22/48

(52) U.S. Cl. 116/212; 280/801.1

(57) ABSTRACT

A tension indicator comprises a housing (1) mountable on a strap S which passes through mouths (5) and (6) of the housing. Within the housing, a barrel (11) is rotatably mounted upon a transverse axis (A). The barrel has a cross-passage (12) for strap (S). Towards its ends barrel (11) has discs (14), carrying slot (15) defining formations (16). The slots engage springs (21). The arrangement is such that in the relaxed state of the springs, barrel passage (12) is out of alignment with mouths (5) and (6), so that a strap (S) passing through the tension indictor is deflected to a lazy Z path. The housing has a window (23), through which barrel (11) can be seen. When springs (21) are relaxed, a “SLACK” portion (24) of barrel (11) can be seen through window (23). When strap (S) is tensioned it is straightened by abutting on ends (25) of passage (12). A different “TENSIONED” portion (26) of barrel (11) now becomes visible in window (23). Thus the tension is strap (S) can be assessed according to which of the portions (24) and (26) is visible in window (23).

The present invention relates to a tension indicator, particularly though not exclusively, for indicating tension in a top tether of a child safety seat.

In an automotive child restraint system, typically a child seat attached to the seat of a car or more precisely to the car at one of its seats, there is a requirement to tension the straps holding the child into the seat and/or the strap(s) tethering the seat in the vehicle. For the former straps, normally this is done by drawing out a central strap, which is attached to and tensions the individual straps, particularly the shoulder straps. In the latter case, tensioning is likely to be by tightening of the strap with a conventional strap adjuster.

Conventional tensioning arrangements have no means by which the user can gauge the tension in the straps, aside from feeling them.

In this specification, the term “tension indicator” is used to mean a device to indicate at least an absence of slack.

The object of the present invention is to provide an indicator for indicating tension in a restraint strap.

According to the invention there is provided a tension indicator comprising:

a housing having:
a window and
a passage through it for a strap,

a pivotable member housed within the housing, the pivotable member having:
a pivot in the housing,
an abutment for the strap spaced from the pivot and out of alignment with the housing passage in at least one pivotal position of the member and
two visual position indicators, respectively visible in the said out of alignment position and an alignment position in which the abutment is in alignment with the housing passage,

a spring for urging the pivotable member into the out of alignment position, the arrangement being such that:

when a slack strap extends through the indicator and the spring has urged the pivotable member into the out of alignment position a “SLACK” one of the indicators is visible through the window and

when the pivotable member is turned against the action of the spring by a tensioned strap urging the abutment into the aligned position a “TENSIONED” one of the indicators is visible through the window.

Normally, at least when the strap is slack, the indicator can be slid along the strap to any conveniently visible position.

Conveniently, the indicators can be provided as a single formation in the pivotable member, with respective indications on it. Whilst it is envisaged that the “SLACK” indication and the “TENSIONED” indication may be words such as these, they are preferably graphic symbols, conveniently the colour red for slack and the colour green for tensioned. The housing is provided with at least one window associated with a pair of visual position indicators. It may be provided with a plurality of windows, at least one of which is associated with a pair of indicators. Suitably it may be provided with two windows, each associated with a pair of indicators, to enable “SLACK” and “TENSIONED” indications to be viewed from either side of the housing. When two or more windows are provided, preferably each window will have a pair of visual position indicators associated with it.

In the preferred embodiment, the pivotable member is a barrel rotatably housed with the housing, the barrel having a passage through it for a strap and the ends of the passage providing two strap abutments. Conveniently the barrel is short and round. However, there is no requirement for the pivotable member to be configured as a barrel.

An envisaged alternative to the barrel configuration is a 7-shaped member, having thickness transverse to the plane of the 7. The pivot is provided at the foot of the 7, pivoted in the housing to one side of the housing passage. The short limb of the 7 provides the indicator formation at the window, to the other side of the passage. The main stem of the 7 has an aperture providing the abutment. In this alternative, the spring can be a torsion coil spring at the pivot.

The spring in the preferred embodiment is a straight element when unstressed and deformed into an S-shape when stressed by alignment of the housing and barrel passages.

To help understanding of the invention, a specific embodiment thereof will now be described by way of example and with reference to the accompanying drawings, in which:

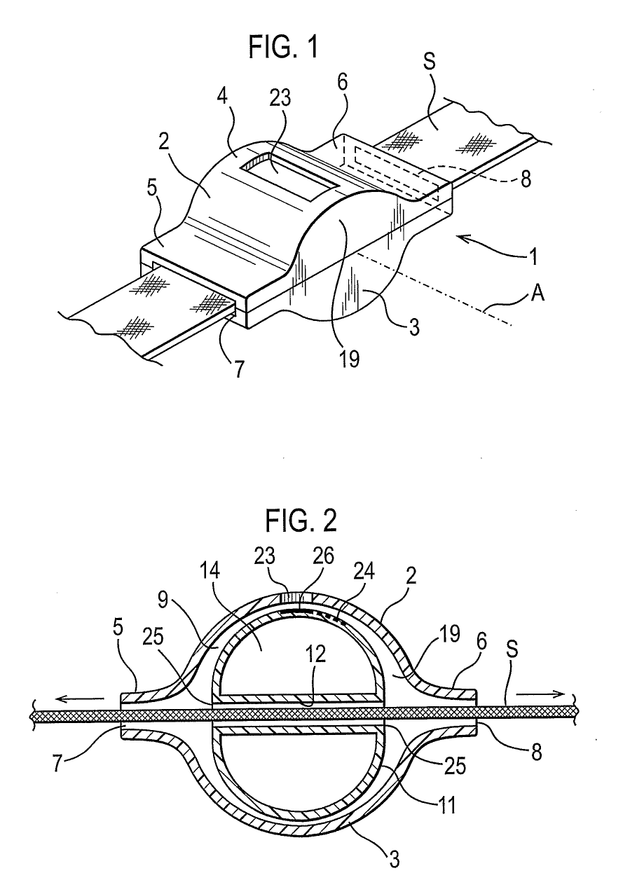

FIG. 1 is a perspective view of a tension indicator according to the invention installed on a strap;

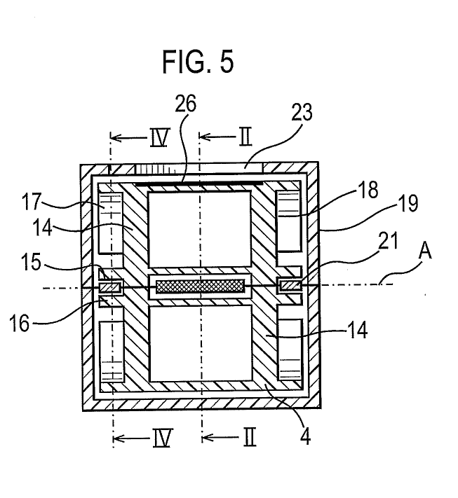

FIG. 2 is a central cross-sectional view of the tension indicator in its state when the strap is tensioned, the view being on the line II-II in FIG. 5;

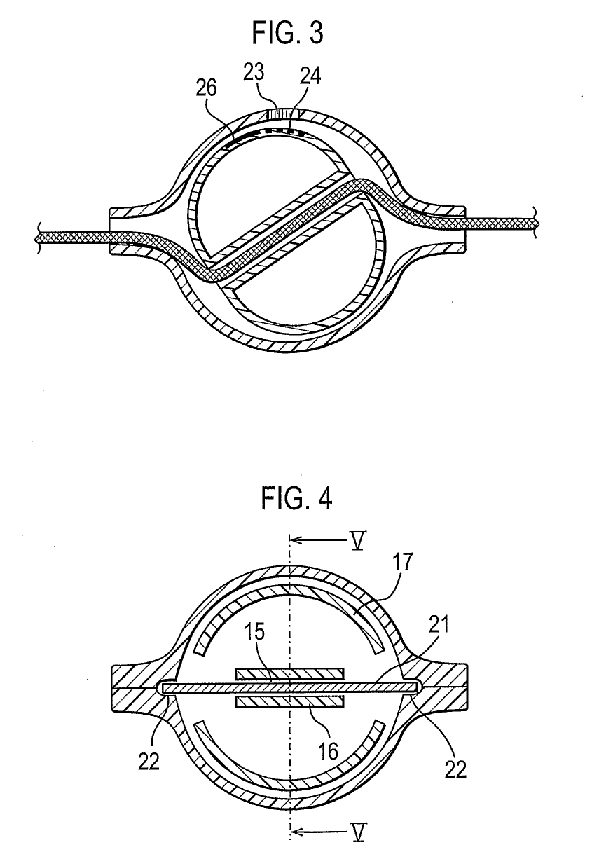

FIG. 3 is a view similar to FIG. 2 with the strap slack;

FIG. 4 is a similar view off-set to the end of the barrel to show a barrel biasing spring, the view being on the line IV-IV in FIG. 5; and

FIG. 5 is a cross-sectional view on the line V-V in FIG. 4.

Referring to the drawings, the tension indicator has a housing 1 comprised of upper and lower plastics mouldings 2,3 clipped or adhered together. The housing has a central body 4 and two extended mouths 5,6, with respective aligned orifices 7,8 directed inwards of the body. The mouths allow a strap S to pass through the housing.

Within the housing, a barrel 11 is rotatably mounted about a transverse axis A. The housing provides a generally circular cylindrical cavity 9, whilst the barrel is a rotary fit in the cavity, so that it can pivot in the housing about its axis A. The barrel is a two part moulding, joined in the manner of the housing. It has a cross-passage 12 for the strap. Towards its ends, the barrel has discs 14, carrying slot 15 defining formations 16. These and extension 17 of the barrel surface 18 abut against side walls 19 of the housing to axially locate the barrel.

The slots engage leaf springs 21 centrally of the springs. The latters' ends engage in recesses 22 formed on the inside of the side walls. The arrangement is that in the relaxed state of the springs, the barrel passage 12 is out of alignment with the mouths 5,6, whereby a strap passing through the tension indicator is deflected to a lazy Z path as shown in FIG. 3.

The housing has a window 23, through which the barrel can be seen. The portion 24 of the barrel visible through the window when the springs are relaxed is colour red to indicate that the strap is slack.

When the strap is tensioned, the tension in it straightens the belt, see FIG. 2, by action of the strap abutting on the ends 25 of the passage 12. A different portion 26 of the barrel is then visible and coloured green. The spring 21 is preferably rated for a relatively low belt tension to straighten it, typically less than 75N. This avoids the belt adopting a path through the barrel which can be straightened, allowing a safety seat unintentional freedom of movement in an accident when the belt tension will be much higher.

Thus the tension in the strap can be assessed according to whether red—SLACK—or green—TENSIONED—is visible through the window. It can also be envisaged that the colour could be graduated, and indeed that a numerical scale of tension could be included.

Since that there is no longitudinal attachment of the indicator to the strap, it can be slid along the strap, at least when the strap is slack.

The invention is not intended to be restricted to the details of the above described embodiment. For instance, the side walls 19 of the housing could be provided with formations complementary to the extensions 17 of the barrel for pivotal location thereof.

Alternative springs, for instance torsional coil, tension coil or compression coil springs could be employed in place of the leaf springs 21, with suitable location formations on the barrel and the housing.

1. A tension indicator which comprises:
(a) a housing having:
(i) a window and
(ii) a passage through it for a strap,
(b) a pivotable member housed within the housing, the pivotable member having:
(i) a pivot in the housing,
(ii) an abutment for the strap spaced from the pivot and out of alignment with the housing passage in at least one pivotal position of the member and
(iii) two visual position indicators, respectively visible in the said out of alignment position and in an alignment position in which the abutment is in alignment with the housing passage,
(c) a spring for urging the pivotable member into the out of alignment position, the arrangement being such that:
(i) when a slack strap extends through the indicator and the spring has urged the pivotable member into the out of alignment position a “SLACK” one of the indicators is visible through the window and
(ii) when the pivotable member is turned against the action of the spring by a tensioned strap urging the abutment into the aligned position a “TENSIONED” one of the indicators is visible through the window.

2. A tension indicator as claimed in claim 1, wherein the pivotable member is a barrel rotatably housed within the housing, the barrel having a passage through it for a strap and the ends of the passage providing two strap abutments.

3. A tension indicator as claimed in claim 2, wherein the barrel is round.

4. A tension indicator as claimed in claim 2, wherein the spring is a straight element when unstressed and is deformed into an S-shape when stressed by alignment of the housing and barrel passages.

5. A tension indicator as claimed in claim 1, wherein the spring is a leaf spring.

6. A tension indicator as claimed in claim 1, wherein the spring is a torsional coil, tension coil or compression coil spring.

7. A tension indicator as claimed in claim 1, wherein the housing has a single window which is associated with two visual position indicators.

8. A tension indicator as claimed in claim 1, wherein the housing has two windows each of which is associated with two visual position indicators.

9. A tension indicator as claimed in claim 1, wherein the visual position indicators are provided as a single formation in the pivotable member, with respective indications on it.

10. A tension indicator as claimed in claim 1, wherein the visual position indicators comprise graphic symbols.

11. A tension indicator as claimed in claim 1, wherein the spring is rated for a belt tension less than 75N.

12. A tension indicator as claimed in claim 1, wherein the pivotable member is a 7-shaped member, having thickness transverse to the plane of the 7.

13. A tension indicator as claimed in claim 12, wherein the spring is a torsion coil spring.

14. An automotive child restraint system which comprises a tension indicator as claimed in claim 13.

15. An automotive child restraint system as claimed in claim 14, which is a child seat, attachable to a car seat, the tension indicator being positioned to indicate the tension in a top tether of the safety seat.
